(19) United States
(12) Patent Application Publication
(10) Pub. No.: US 2021/0120786 A1
(43) Pub. Date: Apr. 29, 2021

(54) TWO-WAY PET COMMUNICATION SYSTEM AND METHOD

(71) Applicant: Brian E Paulus, Stilesville, IN (US)

(72) Inventor: Brian E Paulus, Stilesville, IN (US)

(21) Appl. No.: 16/662,906

(22) Filed: Oct. 24, 2019

(51) Int. Cl. A01K 27/00; A01K 11/00; H04N 5/225; H04R 1/02; H04N 7/18; H04N 5/77

(52) U.S. Cl. CPC A01K 27/009; A01K 11/008; A01K 27/006; H04N 5/77; H04R 1/028; H04N 7/185; H04N 5/2253

(57) ABSTRACT

A two-way pet communication system which provides dogs with a bone-shaped (or other pet-related object shape such as a fire hydrant, ball, or the like) pendant equipped with an audio and visual camera designed to allow for two-way communication between the pet-owner and the dog at any time. The device communicates with a smartphone or other electronic device via WiFi or BLUETOOTH connections, enabling pet owners to speak with their pet and view the camera on the smartphone. The device utilizes a front-facing camera which offers audio communication, providing clear views a pet's location. Further, the device helps keep a host-pet safe at all times, enabling pet owners to communicate with a dog should the dog wander too far away from their home.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of animal husbandry of existing art and more specifically relates to communication means for pets.

### RELATED ART

Many people have pets. Keeping track of a dog while he or she is outdoors can be difficult. People may let dogs run around on their own property without a leash; however, a dog could still manage to move too far from the property and become lost. Owners may be unable to locate their dogs, and serious injuries could occur. A suitable solution is desired.

U.S. Pat. No. 9,510,566 to Theadore Pantazes relates to a wearable canine and feline collar with camera and added features. The described wearable canine and feline collar with camera and added features is a multifunction animal collar. The collar includes a plurality of electronic components for collecting and transmitting audio and visual information to and from a remote user in real time. The plurality of electronic components including a satellite communication chip, a GPS chip, a camera, a thermographic camera, infrared camera, a microphone, a speaker, and a light. The satellite communication chip capable of transmitting and receiving viewed images and sounds to a remote user for viewing on an external electronic device and back to the animal in real time.

### SUMMARY OF THE INVENTION

In view of the foregoing disadvantages inherent in the known animal husbandry art, the present disclosure provides a novel two-way pet communication system. The general purpose of the present disclosure, which will be described subsequently in greater detail, is to provide an effective and efficient means to communicate with a pet.

The present invention, two-way pet communication system, provides dogs with a bone-shaped (or other pet-related object shape such as a fire hydrant, ball, or the like) pendant equipped with an audio and visual camera designed to allow for two-way communication between the pet-owner and his/her dog at any time. The device communicates with a smartphone or other electronic device via WiFi or BLUETOOTH connections, enabling pet owners to speak with their pet and view the camera on the smartphone. The device utilizes a front-facing camera which offers audio communication, providing clear views of where a pet is located. Further, the device helps keep a host-pet safe at all times, enabling pet owners to communicate with a dog should they wander too far away from their home. The present invention offers a simple and convenient method for obtaining real-time video of the dog's view while the dog is in or outdoors.

A two-way pet communication system is disclosed. The system comprises: a two-way pet communication device including a housing (protective shell body) having an outer-surface, an inner-surface, and a hanger, a camera, speakers, a powerer, a receiver, a transceiver, a microchip, and necessary electrical wiring, wherein the housing is defined by the outer-surface and the inner-surface defining an inner-volume and the a hanger is configured for hanging the two-way pet communication device from a host-pet. The camera and speakers are powered by the powerer and the microchip is able to cause the receiver and alternately the transceiver to communicate signals with an external electronic device (such as a smartphone, tablet or the like); and as such the two-way pet communication device is configured for use to facilitate communication between the host-pet and a pet-owner.

According to another embodiment, a method of use for the two-way pet communication system is also disclosed, the method comprising the steps of providing a two-way pet communication device; removably coupling the two-way pet communication device to a leash or collar secured about a neck of a host-pet; and communicating between the host-pet and a pet-owner via video and audio; and optionally locating the host-pet via the video and audio via means described herein.

For purposes of summarizing the invention, certain aspects, advantages, and novel features of the invention have been described. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a two-way pet communication system, constructed and operative according to the teachings of the present disclosure.

FIG. 1 is a perspective view of the two-way pet communication system during an ‘in-use’ condition, according to an embodiment of the disclosure.

FIG. 2 is a perspective view of the two-way pet communication system of FIG. 1, according to an embodiment of the present disclosure.

FIG. 3 is a perspective view of the two-way pet communication device of FIG. 1, according to an embodiment of the present disclosure.

FIG. 4 is a perspective view of the two-way pet communication system as coupled to a collar on a host-pet of FIG. 1, according to an embodiment of the present disclosure.

FIG. 5 is a perspective view illustrating communication of the two-way pet communication system of FIG. 1, according to an embodiment of the present disclosure.

The various embodiments of the present invention will be described with the appended drawings, wherein like designations denote like elements.

### DETAILED DESCRIPTION

As discussed above, embodiments of the present disclosure relate to animal husbandry and more particularly to a two-way pet communication system as used to improve the communication between pets and their owners.

Generally, the Two-Way Camera Dog Collar is a durable, lightweight camera unit for a dog's collar. The pet-related-object-shaped camera unit is capable of both video and audio recording and playback. Pet owners can simply hang (couple) the camera to a dog's collar and connect the camera system wirelessly to a smartphone or other electronic device. Two hangers on opposite ends allow the camera to hang below the head and use gravity to maintain a substantially horizontal orientation. Speakers on the camera unit enable pet owners to hear what the pet is currently hearing while also offering a way to communicate with the pet. The connection between the camera and a smartphone, tablet, etc. can be completed via WiFi or BLUETOOTH or any other contemporary radiocommunication technology Pet owners can view the dog's surroundings through the camera and speak to the pet via the audio playback. Owners may also utilize the audio playback to speak with friends, family, and other pedestrians located near the dog. A pet can be kept safe and owners can identify exactly where a pet is located at all times. Two-Way Camera Dog Collar can be constructed using plastic and other suitable materials. The device will vary in size; however, in some embodiments the maximum width does not exceed 3.25″. Exact size, measurement, construction, and design specifications may vary upon manufacturing.

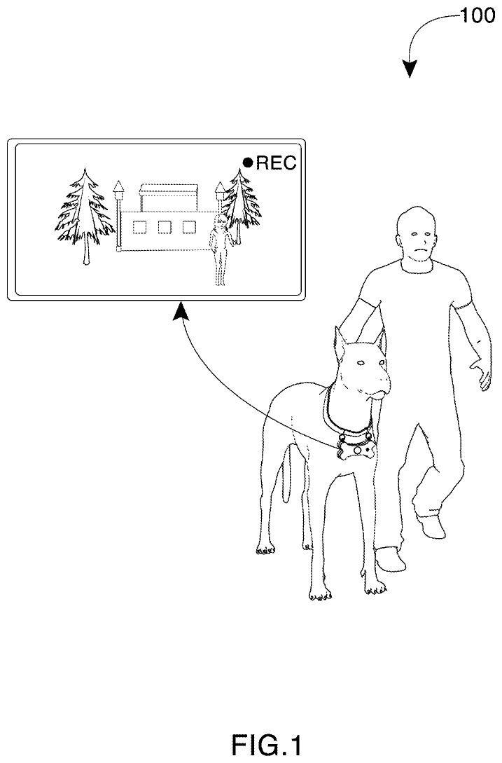

FIGS. 1-5 show various views of a two-way pet communication system 100.

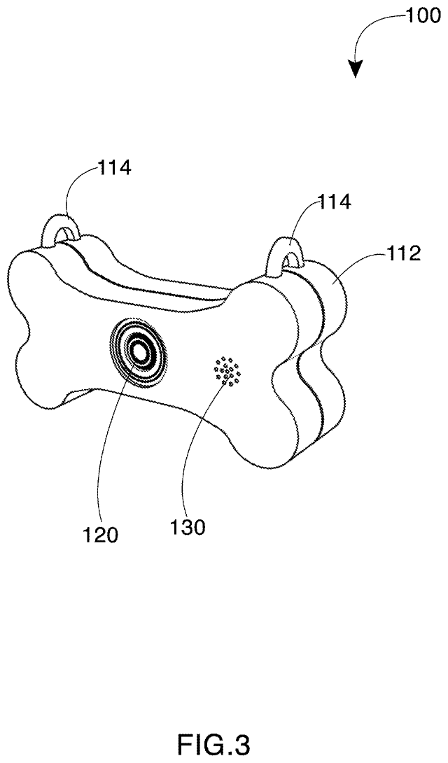

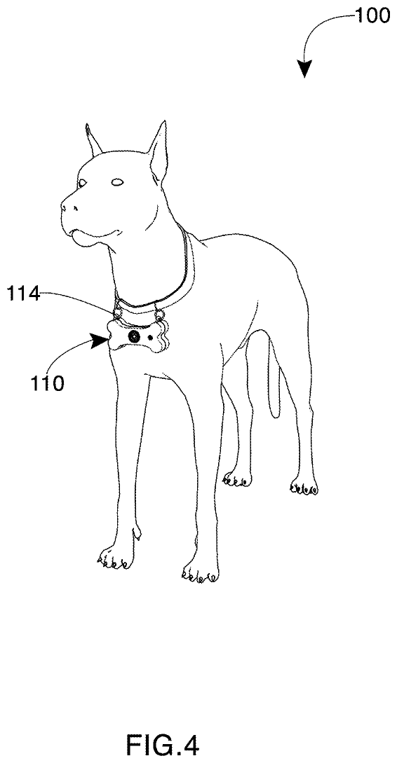

FIG. 1 shows a two-way pet communication system 100 during an ‘in-use’ condition, according to an embodiment of the present disclosure. Here, the two-way pet communication system 100 may enable a user to communicate with their pet. As illustrated in FIGS. 3-4, the two-way pet communication system 100 may include a two-way pet communication device 110 including a housing 112 (protective shell body) having an outer-surface, an inner-surface, and a hanger 114, a camera 120, speakers 130, a powerer, a receiver, a transceiver, a microchip, and the necessary electrical wiring for electrical communication between the various components.

The housing 112 is defined by the outer-surface and the inner-surface forming an inner-volume; the a hanger 114 is configured for hanging the two-way pet communication device 110 from a host-pet, as shown. The camera 120 and speakers 130 are powered by the powerer and the microchip can cause the receiver and (alternately) the transceiver to communicate signals with an external electronic device 102 (such as a smartphone, tablet or the like). As such, the two-way pet communication device 110 is configured for use to facilitate communication between the host-pet and a pet-owner (user).

According to one embodiment, the two-way pet communication system 100 may be arranged as a kit. In particular, the two-way pet communication system 100 may further include a set of instructions. The instructions may detail functional relationships in relation to the structure of the two-way pet communication system 100 such that the two-way pet communication system 100 can be used, maintained, or the like, in a preferred manner.

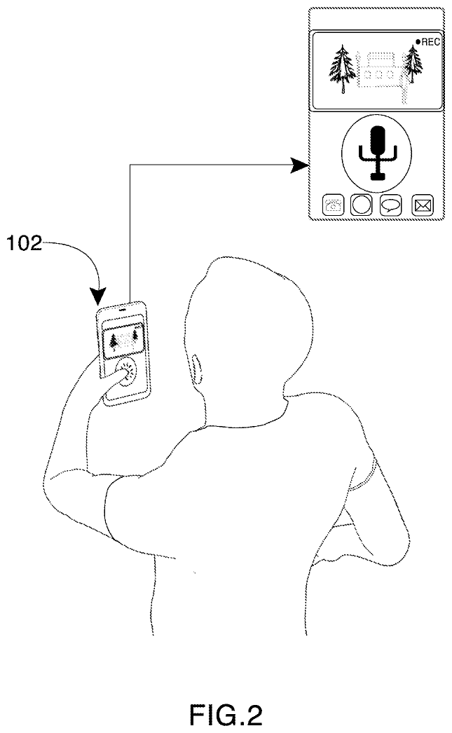

Referring now to FIGS. 2-5 showing various views of the two-way pet communication system 100 of FIG. 1, according to an embodiment of the present disclosure. The speaker 130 and camera 120 are preferably forward-facing during use. Alternate embodiments may have speaker(s) 130 and camera(s) 120 in different orientations. As designed, oriented, and located the at least one speaker 130 allows for communication from the host-pet to the pet-owner and from the pet-owner to the host-pet. The camera 120 is configured to deliver still-shots or video, and as such, the camera 120 is configured to deliver real-time location data of the host-pet in relation to the pet-owner such that the pet-owner can respond accordingly. The two-way pet communication device 110 is thus configured to be able to provide both video and audio recording playback to the pet-owner.

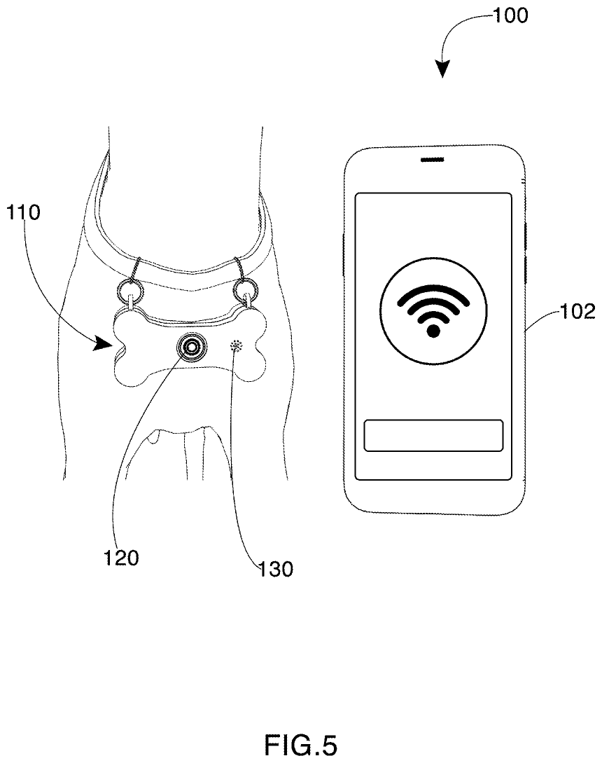

The at least one speaker 130 also allows communication between individuals located near the host-pet and the pet-owner. The two-way pet communication device 110 is designed to be placed in a horizontal orientation during use, as shown in FIGS. 4 and 5. The two-way pet communication device 110 is substantially maintained in the horizontal orientation by two of the hangers 114; wherein the hanger 114 allows for removably coupling the two-way pet communication device 110 to a leash or collar secured about the neck of the host-pet.

The receiver and the transceiver of the two-way pet communication system 100 are configured to communicate signals wirelessly with the external electronic device 102; wherein the external electronic device 102 may or may not be a smartphone. Those with ordinary skill in the art will now appreciate that upon reading this specification and by their understanding the art of sending signals via receivers and transceivers and microchip usage therewith as described, methods of enabling such communication will be understood by those knowledgeable in such art.

A method of use for the present invention may include one or more components or features of the two-way pet communication system 100 as described above. As illustrated, the method for use of the two-way pet communication system 110 may include the steps of step one 501, providing a two-way pet communication device; step two 502, removably coupling the two-way pet communication device to a leash or collar secured about a neck of a host-pet; and step three 503, communicating between the host-pet and a pet-owner via video and audio; and step four 504, optionally locating the host-pet via the video and audio via means described above. The steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use and shapes of the device 110, are taught herein.

The embodiments of the invention are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A two-way pet communication system, the system comprising:
a two-way pet communication device including
a housing having
an outer-surface;
an inner-surface; and
a hanger;
a camera;
a powerer;
a receiver;
a transceiver;
a microchip; and
electrical wiring;
wherein the housing is defined by the outer-surface and the inner-surface defining an inner-volume and the hanger is configured for hanging the two-way pet communication device from a host-pet;
wherein the camera is powered by the powerer;
wherein the microchip is able to cause the receiver and alternately the transceiver to communicate signals with an external electronic device; and
wherein the two-way pet communication device is configured for use to facilitate communication between the host-pet and a pet-owner.

2. The two-way pet communication system of claim 1, further comprising at least one speaker powered by the powerer.

3. The two-way pet communication system of claim 1, wherein the hanger positions the camera forward during use.

4. The two-way pet communication system of claim 2, wherein the system is configured such that the at least one speaker allows for communication from the host-pet to the pet-owner and from the pet-owner to the host-pet.

5. The two-way pet communication system of claim 4,
wherein the hanger positions the camera forward during use.

6. The two-way pet communication system of claim 1, wherein the receiver and the transceiver are configured to communicate signals wirelessly with the external electronic device.

7. The two-way pet communication system of claim 3, wherein the camera is configured to deliver still-shots.

8. The two-way pet communication system of claim 3, wherein the camera is configured to deliver video.

9. The two-way pet communication system of claim 3, wherein the camera is configured to deliver real-time location data of the host-pet in relation to the pet-owner.

10. The two-way pet communication system of claim 1, wherein the two-way pet communication device is configured to provide both video and audio recording playback to the pet-owner.

11. The two-way pet communication system of claim 1, wherein the external electronic device is a smartphone.

12. The two-way pet communication system of claim 1, wherein the external electronic device is not a smartphone.

13. The two-way pet communication system of claim 2, wherein the at least one speaker allows communication between individuals located near the host-pet and the pet-owner.

14. The two-way pet communication system of claim 1, wherein the hanger is designed to cause the device to orient horizontally during use.

15. The two-way pet communication system of claim 14, wherein the hanger substantially maintains the device in the horizontal orientation by two hangers.

16. The two-way pet communication system of claim 1, wherein the a hanger allows for removable coupling of the two-way pet communication device to a collar secured about a neck of the host-pet.

17. A two-way pet communication system, the system comprising:
a two-way pet communication device including
a housing having
an outer-surface;
an inner-surface; and
a hanger;
a camera;
a powerer;
a receiver;
a transceiver;
a microchip;
at least one speaker; and
electrical wiring;
wherein the housing is defined by the outer-surface and the inner-surface defining an inner-volume and the a hanger is configured for hanging the two-way pet communication device from a host-pet;
wherein the camera and the at least one speaker are powered by the powerer connected via the electrical wiring;
wherein the camera and the at least one speaker are forward-facing during use;
wherein the microchip is able to cause the receiver and alternately the transceiver to communicate signals with an external electronic device;
wherein the receiver and the transceiver are configured to communicate signals wirelessly with the external electronic device as determined by the microchip;
wherein the two-way pet communication device is configured for use to facilitate communication between the host-pet and a pet-owner;
wherein the camera is configured to be able to deliver real-time proximity indication of the host-pet in relation to the pet-owner;
wherein the two-way pet communication device is configured to be able to provide both video and audio recording playback to the pet-owner;
wherein the at least one speaker allows communication between individuals located near the host-pet and the pet-owner;
wherein the at least one speaker allows for communication from the host-pet to the pet-owner and from the pet-owner to the host-pet;
wherein the two-way pet communication device is designed to be placed at a horizontal orientation during use.
wherein the two-way pet communication device is substantially maintained in the horizontal orientation by two of the a hanger; and
wherein the a hanger allows for removable coupling of the two-way pet communication device to and from a leash secured about a neck of the host-pet.

18. The two-way pet communication system of claim 17, further comprising set of instructions; and
wherein the two-way pet communication system is arranged as a kit.

19. A method of use for the two-way pet communication system, the method comprising the steps of:
providing a two-way pet communication device of claim 1
removably coupling the two-way pet communication device to a collar secured about a neck of a host-pet;
communicating between the host-pet and a pet-owner via video and audio.

20. The method of claim 19, further comprising the step of locating the host-pet via the video and audio.
